(19) United States
(12) Patent Application Publication
(10) Pub. No.: US 2019/0323885 A1
(43) Pub. Date: Oct. 24, 2019

(54) DEVICE FOR DETERMINING A POSITION OF AT LEAST ONE OBJECT

(71) Applicant: Robert Bosch GmbH, Stuttgart (DE)

(72) Inventors: Mustafa Kamil, Leonberg (DE); Nico Heussner, Ludwigsburg (DE)

(21) Appl. No.: 16/384,145

(22) Filed: Apr. 15, 2019

(30) Foreign Application Priority Data
Apr. 19, 2018 (DE) 102018205972.1

(51) Int. Cl. G01J 1/42; G01S 17/42; G01J 1/08

(52) U.S. Cl. CPC G01J 1/4228; G01J 1/08; G01J 1/4209; G01S 17/42

(57) ABSTRACT

A device for determining a position of at least one object is described, the device including an emitter array, which is configured to cover a field of view of the device, and which includes at least two emitters, which are situated on a support element, each emitter being configured to cover an illumination area. The device provides that the emitters are individually controllable, the illumination area of the emitters being disjunctive and covering the field of view of the device.

The present application claims priority to and the benefit of German patent application no. 10 2018 205 972.1, which was filed in Germany on Apr. 19, 2018, the disclosure which is incorporated herein by reference.

### FIELD OF THE INVENTION

The present invention relates to a device for determining a position of at least one object, the device including an emitter array, which is configured to cover a field of view of the device, and which includes at least two emitters that are situated on a support element, each emitter being configured to cover an illumination area.

### BACKGROUND INFORMATION

Such a device is also referred to as LIDAR (originally a portmanteau of light and radar). Such LIDAR systems are presently normally configured as rotating scanners, micro-scanners or flash systems. Among these systems, so-called solid state LIDAR systems provide certain advantages. These manage without mechanically moving parts. As a result, mechanisms and deflection mechanisms may be saved on the one hand; defects are prevented on the other hand.

The emitter array of the device is configured to cover a field of view (FOV) of the device. Thus, the emitter array is configured to emit transmitted light signals, which cover, i.e., illuminate and therefore detect, the entire solid angle area of the field of view. The transmitted light signals are emitted by the individual emitters of the emitter array. In the process, each of these individual emitters covers an illumination area, which represents a solid angle area that is smaller than the field of view of the device. This illumination area includes the transmitted light signal of the respective emitter and is illuminated by the emitter.

In a flash system of a LIDAR, the entire field of view of the device is illuminated simultaneously by all emitters of the emitter array. This has certain disadvantages. On the one hand, a chronological as well as spatially concentrated illumination takes place, which represents a danger for the eye safety of users or uninvolved third parties. On the other hand, the spatial concentration of the lighting output also results in saturation effects by bright objects in the near field, a high crosstalk probability with other flash systems, high required peak outputs and the lack of ability to adaptively adjust the field of view during operation. Finally, the frame rate may also not be increased without increasing the illumination output relevant for eye safety, since individual emitters may not be switched off in order to compensate.

An array-based light detection and ranging unit (LIDAR), including a field-like array of emitters/detector sets is discussed in WO 2015/126471 A2, which is configured in such a way that it covers a field of view (FOV) for the unit. Each emitter/detector set emits and receives light energy on a specific coincident axis that is unique for this emitter/detector set. A control system coupled to the array of emitters/detector sets controls the emission of light energy for each individual emitter and processes the time of flight information for the reflected light energy received on the coincident axis by the corresponding detector for the respective emitter/detector set. To increase the SNR (signal-to-noise ratio), the emitters may be fired sequentially one after the other or time-delayed in groups.

A high-resolution LIDAR system that includes a plurality of photon emitters and photon detectors, which are situated within a rotatably mounted housing and which are operated with the aid of variable firing sequences, is known from EP 2 388 615 A1. In addition, the SNR may be increased by adaptive power adaptation and a variable firing pattern.

### SUMMARY OF THE INVENTION

According to the present invention, a device is provided, in which the emitters are individually controllable, the illumination areas of the emitters being disjunctive and covering the field of vision of the device.

The individual illumination areas of the emitters are directly adjacent to one another; they have no overlap and they leave no gaps. Partitioning the field of view of the device into numerous individual emitters of the emitter array results in an areal illumination of the entire field of view. Each emitter in this case is individually controllable, so that individual (solid angle) areas of the field of view may be individually illuminated or left unilluminated. A quasi-rotation or a quasi-scan movement similar to a macro-scanner may be emulated. Mechanically moving parts may, however, be completely omitted. In this case, there is no apparent difference in the illumination with respect to the field of view of the device between the device according to the present invention and, for example, a macro-scanner, since the individual illumination areas of the emitters completely cover the field of view of the device.

In this case, it is preferred that the support element is configured as a plane, and an angle of inclination of the emitter increases relative to a normal central axis of the plane with increasing distance from the central axis.

In this way, an areal illumination for covering the field of view of the device may be achieved with the aid of the individual illumination areas of the emitters in a horizontal as well as in a vertical component of the field of view. The support element is a plane that includes the horizontal and vertical components of the field of view. The central axis of the support element extends through a center point (for example, a geometric center point) of the support element and is situated vertically (normally) on the support element. In this planar support element, the emitters of the emitter array are then placed in a horizontal and vertical direction. This placement takes place at an angle of inclination of the emitters relative to the central axis. Thus, the emitter, which is situated coaxially to the central axis in the center of the support element, has an angle of inclination of 0° (i.e. of 90° relative to the horizontal component and vertical component of the support element). The angle of inclination of the emitters then increases with increasing distance from the central axis. The entire field of view of the device may then be detected with the aid of the individual illumination areas of the emitters.

It is also preferred that the support element is configured as a free-form surface, in particular, as a spherical section, a cylindrical section or an ellipsoid section, and includes circuit boards situated in a planar manner.

The free-form surface in this case covers the entire field of view of the device. It may also be provided to configure multiple individual free-form surfaces, which allow for a mesh-like discrete approximation or lining of the field of view. For this purpose, the support element may have the shape of a spherical section, of a cylindrical section or of an ellipsoid section. The resulting free-form surface may be lined with circuit boards, which may be attached. This allows the adjustment effort to be reduced, since each circuit board may be identically fabricated and the support element is mathematically easily describable and, as a result may be manufactured, for example, in a 3D printer or in an injection molding process.

In another advantageous specific embodiment, the device includes a control unit, which is configured to sequentially activate the emitters or a group of emitters.

By sequentially activating individual emitters or groups of emitters, it is possible in a flash LIDAR approach to emulate a rotation or a mechanical scan movement. A scanning LIDAR system may be implemented with the aid of the device, which has no mechanical components. The omission of individual emitters when illuminating the field of view triggers a reduction of the transmission power of the device, thereby increasing the eye safety for the user or for uninvolved third parties. A possibility for increasing the signal-to-noise ratio (SNR) may also result: by omitting individual emitters, it is possible to ascertain background noise levels at the non-illuminated positions in the field of view. These may then be used to improve the signal-to-noise ratio (SNR) at the illuminated positions (Background Subtraction).

In this case, the group of emitters may be formed from a horizontal column, from a vertical row, from a spot or from a square of emitters. In this way, a mechanical scan movement may be simply emulated. By selecting the geometric pattern as a horizontal column, a vertical row, a spot or a square, the group of emitters may cover the entire field of view. Omitting individual emitters or groups of emitters reduces the transmission power of the device and increases the eye safety for the user or for uninvolved third parties.

The control unit may be configured to activate the emitters or group of emitters sequentially spatially according to a pseudo-random distribution or according to a spatially intelligent distribution.

Here, an arbitrary scan pattern may be used to improve the signal-to-noise ratio (SNR) as compared to a sequential illumination of directly adjacent pixels, since the crosstalk with adjacent pixels is ruled out due to the spatial separation. When using a random scan pattern, a crosstalk with other flash-LIDAR systems is also minimized (chronological and spatial decoupling).

A device is also provided, in which the control unit is configured to activate the emitter or the group of emitters sequentially in a time-shifted manner.

The emulation of a mechanical scan movement may also be implemented with the aid of a time-shifted activation of individual emitters or groups of emitters. For example, a first vertical row or a first horizontal column of four emitters may be fired at a first point in time. At a second point in time, a second vertical row or a second vertical column of four additional emitters may then also be fired. This pattern is repeated until the entire field of view is covered. In addition to columns and rows, it is also possible to use spots, squares or other geometric patterns. The respective rows and/or columns in this case need not be spatially adjacent to one another at successive points in time of the firing of the emitters.

The control unit may be configured to control a transmission power of an emitter or of a group of emitters.

Reducing the transmission power of the individual emitters or groups of emitters increases, in turn, the eye safety. This allows for a more frequent emission of pulses, i.e., transmitted light signals of the emitters. The result is fewer simultaneous pulses, but an increased frame rate.

Finally, the device may include at least one detector or at least two detector elements, the position of which is matched to a position of the emitters.

With the at least one detector, it is thus possible to decouple the reception path of the device from its transmission path. A 2D detector array, for example, is useful for such purpose. In addition, the bandwidth of a bandpass filter upstream from the detector may be advantageously reduced by properly angled emission of different wavelengths.

When using at least two detector elements, the detector elements may be partitioned in the same number and distribution as the emitters and each may be situated as a single detector or detector groups on the same circuit board next to the respective emitter. In this way, the incident angle of a received light signal on the bandpass filter upstream from the detector element and a parallaxis effect are advantageously reduced. The reception path of the device is partitioned.

Finally, the control unit may be configured to adaptively shift the field of view.

The result is a variability of the field of view. This is achieved by targeted activation of individual emitters or groups of emitters. If, for example, the measurement range of the device is selected to be greater than a useable field of view, there is the possibility of adaptively shifting the field of view during operation of the device. Examples mentioned here are applications from the automotive use of the device. Thus, either the field of view may be carried along during the negotiation of curves of a vehicle counter to a vehicle rotation rate by activating individual emitters or groups of emitters. Or, individual, selected objects in the measurement range (region of interest) may be exclusively tracked, while simultaneously removing image areas of no interest (sky, road, etc.).

Exemplary embodiments of the present invention are explained in greater detail with reference to the drawings and to the following description.

### BRIEF DESCRIPTION OF THE DRAWINGS

FIG. 1 schematically shows a representation of a field of view of a device according to the present invention, which includes a support element according to a first exemplary embodiment.

FIG. 2 schematically shows a representation of a field of view of a device according to the present invention, which includes a support element according to a second exemplary embodiment.

FIG. 3 schematically shows a representation of a field of view of a device according to the present invention, which includes a first horizontal column and a second horizontal column.

### DETAILED DESCRIPTION

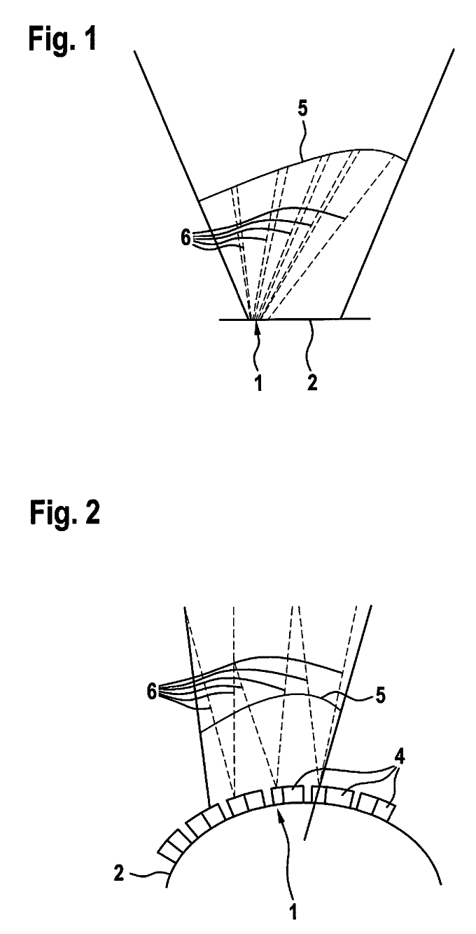

A detail of a device for determining a position of at least one object is schematically shown in FIG. 1. The device in this case includes an emitter array 1, which is situated on a support element 2. Emitter array 1 includes a plurality of emitters 3, which are situated on a circuit board 4 (cf. FIG. 2). The device further includes a schematically represented field of view 5. Each of emitters 3 is configured to cover an illumination area 6.

The individual emitters 3 are each individually controllable. The individual illumination areas 6 of emitters 3 are disjunctive and completely cover field of view 5 of the device, as illustrated in FIG. 1. Illumination areas 6 illuminated by emitters 3 are directly adjacent to one another, have no overlap and leave no gaps.

In the exemplary embodiment of the device shown, support element 2 is configured as a plane (i.e., a support plate), which extends in a horizontal direction as well as a vertical direction. It is apparent in the exemplary embodiment that individual emitters 3 have an angle of inclination relative to a normal central axis of support element 2. This angle of inclination increases with the distance of emitters 3 from the central axis. This may result in the entire field of view 5 being covered with the aid of individual illumination areas 6 of emitters 3.

FIG. 2 shows an alternative specific embodiment of the device, in which support element 2 is configured as a free-form surface—here: a spherical section. Circuit boards 4 are situated in a planar manner on support element 2. These may be attached. The adjustment effort is reduced as a result, since each circuit board 4 may be fabricated identically. Support element 2 has a mathematically easily describable shape and may be easily manufactured in a 3D printer or in an injection molding process.

Disjunctive illumination areas 6 of emitters 3 completely cover field of view 5 of the device in the exemplary embodiment of FIG. 2 as well. They are directly adjacent to one another, have no overlap and leave no gaps.

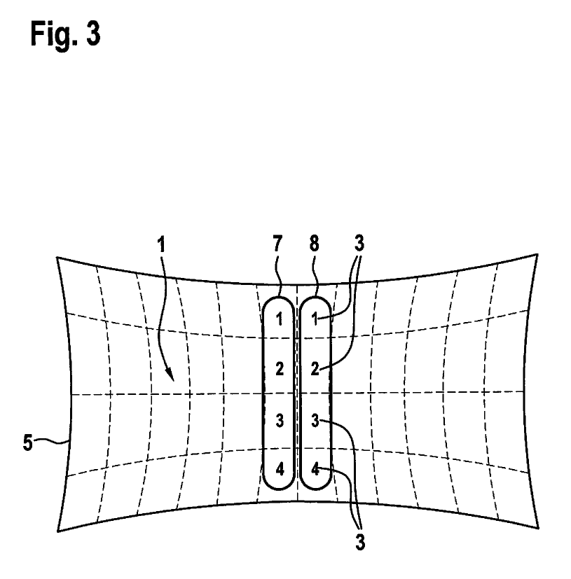

FIG. 3 shows a possible firing sequence of a group of emitters 3 of the device. Individual emitters 3 are combined in field of view 5 of the device in groups of four emitters 3 each in horizontal columns 7, 8. A first horizontal column 7 and a second horizontal column 8 are shown by way of example.

These groups of emitters 3 may be fired sequentially. Sequential firing in this case may relate on the one hand to a spatial succession of group of emitters 3—first horizontal column 7 and second horizontal column 8 are spatially adjacent. This is not mandatory, however. A pseudo-random spatial distribution of emitters 3 or groups of emitters 3 may also be provided. On the other hand, the sequential firing may relate to a chronological sequence of firings of emitters 3 or of groups of emitters 3. Thus, for example, first horizontal column 7 may be fired at a first point in time, followed by second horizontal column 8 at a second point in time.

With this sequential firing of emitters 3 or of groups of emitters 3, it is possible in a flash LIDAR approach of the device to emulate a rotation or another mechanical scan movement. However, mechanical parts may also be completely omitted here. A difference in field of view 5 of the device is not perceivable from the outside, since individual illumination areas 6 completely cover field of view 5.

This also results in a variability of field of view 5 of the device. If, for example, the measurement range of the device is selected to be greater than a useable field of view 5, there is the possibility of adaptively shifting field of view 5 during operation. Examples of this in automotive use are either the tracking of field of view 5 during the negotiation of curves counter to a vehicle rotation rate or the exclusive tracking of individual, selected objects in the measurement range (region of interest) while removing image areas of no interest (sky, road, etc.).

What is claimed is:

1. A device for determining a position of at least one object, comprising:
an apparatus, including:
an emitter array to cover a field of view of the apparatus, and which includes at least two emitters, which are situated on a support element, each of the emitters being configured to cover an illumination area, wherein the emitters are individually controllable, and wherein the illumination areas of the emitters are disjunctive and covering the field of view of the device.

2. The device of claim 1, wherein the support element is configured as a plane, and an angle of inclination of the emitters relative to a normal central axis of the plane increases with increasing distance from the central axis.

3. The device of claim 1, wherein, the support element is configured as a free-form surface, and which includes circuit boards situated in a planar manner.

4. The device of claim 1, further comprising:
a control unit to sequentially activate the emitters or a group of the emitters.

5. The device of claim 4, wherein the group of emitters is formed from one of a horizontal column, a vertical column, a spot, or a square of the emitters.

6. The device of claim 4, wherein the control unit is configured to activate the emitters or the group of emitters sequentially spatially according to a pseudo-random distribution or according to a spatially intelligent distribution.

7. The device of claim 4, wherein the control unit is configured to activate the emitters or the group of emitters sequentially in a time-shifted manner.

8. The device of claim 4, wherein the control unit is configured to control a transmission power of an emitter or of a group of the emitters.

9. The device of claim 1, wherein the device includes at least one detector or at least two detector elements, the position of which is matched to a position of the emitters.

10. The device of claim 4, wherein the control unit is configured to adaptively shift the field of view.

11. The device of claim 1, wherein, the support element is configured as a free-form surface, which includes a spherical section, a cylindrical section or an ellipsoid section, and which includes circuit boards situated in a planar manner.

12. The device of claim 1, wherein the device includes at least one detector, the position of which is matched to a position of the emitters.

13. The device of claim 1, wherein the device includes at least two detector elements, the position of which is matched to a position of the emitters.
